(19) United States
(12) Patent Application Publication
(10) Pub. No.: US 2022/0170262 A1
(43) Pub. Date: Jun. 2, 2022

(54) SELF-ADHERING DRAINAGE/VENTILATION BARRIER FOR BUILDINGS

(71) Applicant: Advanced Building Products, Inc., Sanford, ME (US)

(72) Inventor: Keith A. Lolley, Sanford, ME (US)

(21) Appl. No.: 17/535,278

(22) Filed: Nov. 24, 2021

Related U.S. Application Data
(60) Provisional application No. 63/120,328, filed on Dec. 2, 2020.

(51) Int. Cl. E04B 1/70; B32B 7/14; B32B 5/02; B32B 5/26; E04B 1/62

(52) U.S. Cl. CPC E04B 1/7069; B32B 7/14; B32B 5/022; B32B 2419/00; B32B 5/273; E04B 1/625; B32B 2307/7246; B32B 5/028

(57) ABSTRACT

A drainage/ventilation product is placed in a budding structure. The product includes: a weather barrier membrane faces away from the building structure; a drainage structure affixed to and co-extensive with the weather barrier membrane; a moisture resistant layer affixed to and co-extensive with the drainage structure; an adhesive layer, the adhesive layer is a plurality of adhesive strips and/or scatter coated over and co-extensive with the moisture resistant layer, the adhesive is a pressure sensitive adhesive (PSA) and has a pull adhesion in a range of about 10-21 psi, and covers about 40-95% of a surface of the moisture resistant layer; and a release layer releasably covers and is co-extensive with the adhesive layer. Whereby the moisture/ventilation product is placed on the building structure without mechanical fasteners. A method is also disclosed.

### RELATED APPLICATION

This application claims the benefit of co-pending U.S. Provisional Patent Application Ser. No. 63/120,328 filed Dec. 2, 2020, incorporated herein by reference.

### FIELD OF THE INVENTION

The invention disclosed herein is directed to a self-adhering drainage/ventilation barrier product that reduces or eliminates the intrusion of moisture (water) into a building structure.

### BACKGROUND OF THE INVENTION

In the construction industry, particularly in residential construction, the accumulation of moisture within the structure, e.g., walls, floors, and roof, should be avoided. For example, it is commonplace to use a ‘house wrap’ over the exterior frame of the structure, e.g., between the sheathing covering the frame and the exterior veneer or cladding. The house wrap is fastened to the frame with mechanical fasteners, e.g., nails/staples. Regrettably, those fasteners create holes through the house wrap, and those holes may be points of water/ moisture intrusion. To improve drainage/ventilation within the structure and thereby minimize moisture/water intrusion issues, barrier products are offered. These barrier products may include a ventilation structure (e.g., an entangled net) bonded to a weather barrier membrane (e.g., perforated sheet or permeable nonwoven). One such product is commercially available under the trade name MORTAIRVENT® rainscreen from Advanced Budding Product, Inc. of Sanford, Me. Until now, these barrier products were fastened to the structure with the previously mentioned mechanical fasteners, which can create holes.

There is a need for barrier product that, among other things, minimizes or eliminates moisture/water intrusion, caused, for example, by holes created by mechanical fasteners.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an environmental view illustrating an embodiment of the invention in place on a building.

FIG. 2 is an exploded cross-sectional view of an embodiment of the invention.

FIG. 3 is an illustration of a ‘waffle’ configuration of an entangled net.

### SUMMARY OF THE INVENTION

A drainage/ventilation product is placed on a building structure. The product includes: a weather barrier membrane facing away from the building structure; a drainage structure affixed to and co-extensive with the weather barrier membrane; a moisture resistant layer affixed to and co-extensive with the drainage structure; an adhesive layer, the adhesive layer is a plurality of adhesive strips and/or scatter coated adhesive over and coextensive with the moisture resistant layer, the adhesive is a pressure sensitive adhesive (PSA); and a release layer releasably covers and is co-extensive with the adhesive layer. Whereby the drainage/ventilation product is placed on the building structure without mechanical fasteners. A method is also disclosed.

### DESCRIPTION OF THE INVENTION

In the Figures, there is shown an embodiment of the drainage/ventilation product 10 disclosed hereinafter.

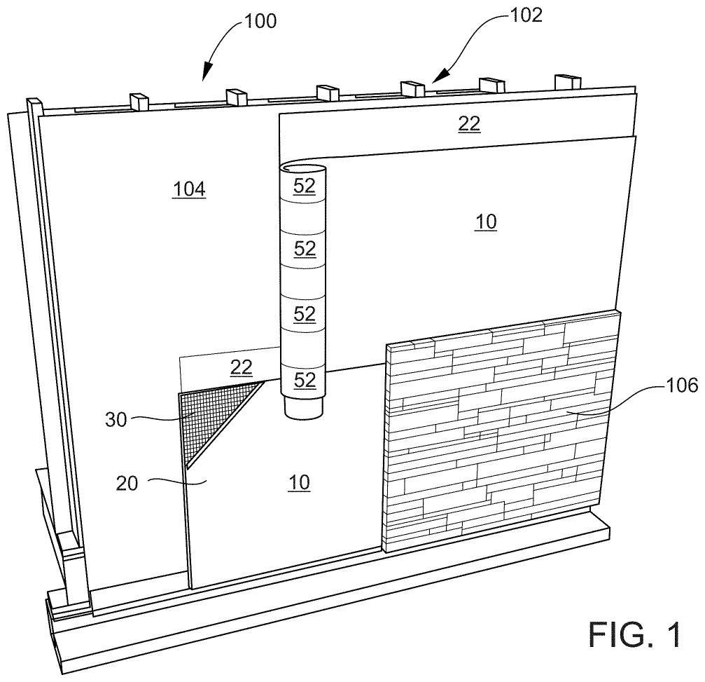

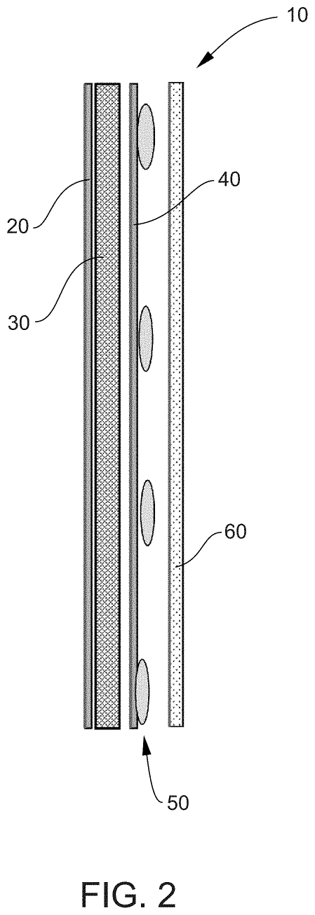

In general, see FIGS. 1 and 2, the drainage/ventilation product 10, may be a roll good and is placed on an exterior surface 104 of a building structure 100 (e.g., residential, or commercial). Building 100 is conventional, for example with a stud wall 102 with sheathing 104 and an exterior veneer 106. The sheathing 104 may be any conventional sheathing. For example, the sheathing 104 may be OSB and/or plywood and/or rigid foam insulation applied over the stud frame, or the sheathing 104 may be a combination of OSB and/or plywood and/or rigid foam insulation covered with a weather resistant barrier. Since seams of the sheathing 104 may be taped, to reduce airflow through the wall structure, use of the product 10 would reduce the need for this taping, since the self-adhering product 10, in effect, may replace the taped seams.

The drainage/ventilation product 10 includes: a weather barrier membrane 20 facing away from the building structure 100; a drainage structure 30 affixed to and co-extensive with the weather barrier membrane 20; a moisture resistant layer 40 affixed to and co-extensive with the drainage structure 30; an adhesive layer 50, the adhesive layer 50 is a plurality of adhesive strips 52 and/or scatter coated adhesive (not shown) covering the moisture resistant layer 50; and a release layer 60 releasably covers and is co-extensive with the adhesive layer 50, whereby the moisture/ventilation product 10 is placed on the building structure without mechanical fasteners. The product 10's layers (weather barrier membrane 20, drainage layer 30, moisture resistant layer 40, and adhesive layer 50) are joined together (or adhered to each other) so as to form a unitary, multilayered structure and each layer is generally co-extensive with the other layers.

The drainage/ventilation product 10 is breathable or permeable with a perm rating of about 9-17 perms as defined by ASTM E96. Alternatively, an embodiment of product 10 may have a perm in the range of about 6-20, and another embodiment may a perm in the range of about 11-16. These perm ratings also include all subsets covered by these ranges.

The drainage/ventilation product 10 has an exposure rating of, at least, about 180 days as defined by ICC-ES AC48. In other embodiments, the exposure rating may be, at least, about 150 days, or about 120 days.

The weather barrier membrane 20 is nonwoven and/or a perforated film. The weather barrier 20 limits the intrusion of moisture (water), but is also breathable. It is inevitable that some moisture will enter the building, so this barrier is breathable to allow moisture to escape. The weather barrier 20 may be made from thermoplastics and may be in the form of a spunbond nonwoven, meltblown nonwoven, and/or a combination of meltblown and spunbond nonwovens. These thermoplastic materials may include: polypropylene, nylon (e.g., nylon 6), and/or polyethylene (e.g., HDPE). The weather barrier membrane 20 may be a coated membrane with enhanced air and water vapor permeance and water resistance. The weather barrier membrane 20 may be commercially available from, for example: GCP Applied Technologies, Inc. of Cambridge, Mass. as WCOR® enV-S™, Product Data Sheet incorporated herein by reference; and Functional Coatings LLC of Newburyport, Mass. as ‘Permeable Self-adhered Air Barrier Membrane,’ Product Data Sheet incorporated herein by reference.

In one embodiment, the weather barrier membrane includes a flap 22 extending beyond one edge of the drainage structure 30, see FIG. 1. This flap 22 facilitates installation of the product 10 by providing an alignment guide during the layout of the product 10, and may eliminates an open seam between adjacently placed product 10.

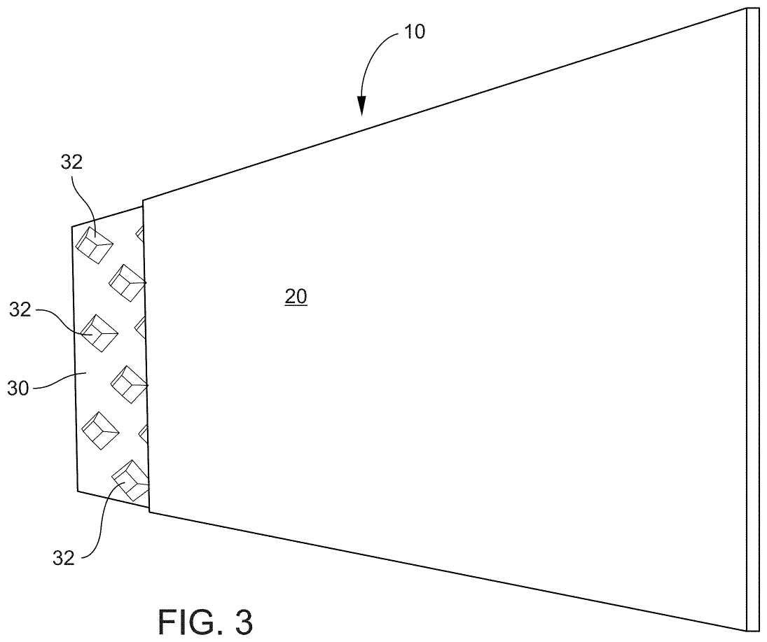

The drainage structure 30 is an entangled net. This drainage structure facilitates movement of moisture (water) within the product, so that moisture (water) may escape, for example, through drains or vents, e.g., weep holes (conventional and not shown), in a lower part of the building wall. Entangled nets are known and may be in either of two general forms: 1) a solid formed of a plurality of entangled fibers (filaments or continuous fibers), for example see U.S. Pat. Nos. 7,096,630, 8,146,310, and 8,544,218 (such as a scrubbing pad); or 2) a sheet of entangled fibers (filaments or continuous fibers) where the sheet is molded or folded (e.g., forming, for example, a sine curve (or corn rows) in cross-section (also referred to as ‘channels’), or ‘peaks and furrows’ (or ‘W’)) (also referred to as ‘channels’), or dimpled or waffle (e.g., cone-shaped, pyramidal-shaped including truncated cones or pyramids, for example see FIG. 3 truncated pyramids 3) to create a three-dimensional solid, for example see U.S. Pat. No. 8,528,286. Entangled nets are known, for example see U.S. Pat. No. 7,096,630, US2006/0230699; U.S. Pat. Nos. 8,146,310; 8,544,218; and 8,528,286, each incorporated herein by reference. In general, the fibers of the entangled net create an open solid (open in the sense of the interstitial spaces between the fibers). The drainage structure 30 may be made of thermoplastic materials. These thermoplastic materials may include: polypropylene, nylon (e.g., nylon 6), and/or polyethylene (e.g., HDPE). The drainage structure may have a thickness in the range of about 3-20 mm (including all subsets of the range).

The moisture resistant layer 40 may be a film membrane or nonwoven membrane. The nonwoven may be a spunbond nonwoven, meltblown nonwoven, and/or a combination of meltblown and spunbond nonwovens. The resistant layer 40 may be made of thermoplastic materials. These thermoplastic materials may include: polypropylene, nylon (e.g., nylon 6), and/or polyethylene (e.g., HDPE). The moisture resistant layer 40 may be a coated membrane with enhanced air and water vapor permeance and water resistance. The moisture resistant layer 40 may be commercially available from, for example: GCP Applied Technologies, Inc. of Cambridge, Mass. as VYCOR® enV-S™, Product Data Sheet incorporated herein by reference; and Functional Coatings LLC of Newburyport, Mass. as ‘Permeable Self-adhered Air Barrier Membrane,’ Product Data Sheet incorporated herein by reference.

The adhesive layer 50 may be a plurality of adhesive strips and/or scatter coated over the resistant layer 40. The adhesive may be any adhesive. In one embodiment, the adhesive is a pressure sensitive adhesive (PSA). These PSAs may be produced using latexes synthesized via a starved seeded semi-batch emulsion polymerization process with butyl acrylate (BA), methyl methacrylate (MMA) and sometimes additional monomers, 2-hydroxy ethyl methacrylate (HEMA) and/or acrylic acid (AA). In an embodiment, the PSA is based on acrylic and/or butyl polymers. In another embodiment, the adhesive may have a pull adhesion, ASTM 14641, in a range of about 10-21 psi, in another embodiment in a range of about 14-18 psi, in yet another embodiment in a range of about 16 psi (including all subsets of the ranges). The adhesive, in some embodiments, may have a peel adhesion (ASTM D3330 Method F), in a range of about 2-7 lbf/in, in another embodiment in a range of about 2.5-6.0 lbf/in, and in yet another embodiment in a range of about 3-5.5 lbf/in (including all subsets of the ranges). The adhesive need not cover the entire (100%) of the resistant layer 40. In some embodiments, the adhesive covers about 50-90% of the surface of the resistant layer 40. In other embodiments, the adhesive covers about 40-95% of that surface or about 60-85% of that surface (including all subsets of those ranges).

The release layer 60 has a silicone surfaced adjacent the adhesive layer. In one embodiment, the release layer 60 may be ‘split’ For example, in the horizontal layout illustrated in FIG. 1, the release layer 60 may be split into an upper portion and lower portion, so that in installation the upper portion may be adhered first (to ensure proper alignment) and then the lower portion adhered with final positioning.

In use, the drainage/ventilation product 10 is placed/affixed to the building structure 100 without mechanical fastener (e.g., nails and/or staples) and using the flap 22 as a guide. Adhesive layer is placed against the building structure (e.g., a housewrap or exterior sheathing) so that the weather resistant barrier faces away from the building structure, Moisture (water) may be removed by allowing air to circulate through the drainage structure

The present invention may be embodied in other forms without departing from the spirit and the essential attributes thereof, and, accordingly, reference should be made to the appended claims, rather than to the foregoing specification, as indicating the scope of the invention.

1. A drainage/ventilation product placed in a budding structure comprises:
a weather barrier membrane faces away from the building structure, the weather barrier is nonwoven and/or a perforated film, and the nonwoven is a spunbond nonwoven, meltblown nonwoven, and/or a combination of meltblown and spunbond nonwovens;
a drainage structure affixed to and co-extensive with the weather barrier membrane, the drainage structure is an entangled net with a channel configuration or a waffle configuration;
a moisture resistant layer affixed to and co-extensive with the drainage structure, the moisture resistant layer is a film or nonwoven;
an adhesive layer, the adhesive layer is a plurality of adhesive strips and/or scatter coated over and co-extensive with the moisture resistant layer, the adhesive is a pressure sensitive adhesive (PSA) based on acrylic and/or butyl polymers, the adhesive has a pull adhesion in a range of about 10-21 psi, the adhesive covers about 40-95% of a surface of the moisture resistant layer; and
a release layer releasably covers and is co-extensive with the adhesive layer,
whereby the moisture/ventilation product is placed on the building structure without mechanical fasteners.

2. The drainage/ventilation product of claim 1 having a perm of about 6-20, or about 9-17, or about 11-16.

3. The drainage/ventilation product of claim 1 where in the pull adhesion is in a range of about 14-16 psi.

4. The drainage/ventilation product of claim 1 wherein the adhesive has a peel adhesion in a range of about 27 lbf/in, or a range of about 2.5-6.0 lbf/in, or in a range of about 3-5.5 lbf/in.

5. The drainage/ventilation product of claim 1 wherein the adhesive covers about 50-90% of the surface of the resistant layer, or about 60-85% of the surface of the resistant layer.

6. The drainage/ventilation product of claim 1 wherein the weather barrier membrane includes a flap.

7. The drainage/ventilation product of claim 1 having an exposure rating of at least about 120 days.

8. The drainage/ventilation product of claim 1 wherein the release layer has a silicone surfaced adjacent the adhesive layer.

9. The drainage/ventilation product of claim 1 wherein the release layer is split layer.

10. A drainage/ventilation product placed in a building structure comprises:
a weather barrier membrane faces away from the budding structure, the weather barrier is nonwoven and/or a perforated film, the nonwoven is a spunbond nonwoven, meltblown nonwoven, and/or a combination of meltblown and spunbond nonwovens, and the weather barrier has a flap;
a drainage structure affixed to and co-extensive with the weather barrier membrane, the drainage structure is an entangled net with a channel configuration or a waffle configuration;
a moisture resistant layer affixed to and co-extensive with the drainage structure, the moisture resistant layer is a coated film or nonwoven;
an adhesive layer, the adhesive layer is a plurality of adhesive strips and/or scatter coated over and co-extensive with the moisture resistant layer, the adhesive is a pressure sensitive adhesive (PSA) based on acrylic and/or butyl polymers, the adhesive has a pull adhesion in a range of about 10-21 psi and a peel adhesion in a range of about 2-7 lbf/in, the adhesive covers about 40-95% of a surface of the moisture resistant layer; and
a release layer releasably covers and is co-extensive with the adhesive layer and is a split layer,
whereby the moisture/ventilation product has a perm in a range of 6-20, an exposure rating of at least about 120 days, and is placed on the building structure without mechanical fasteners.

11. A method for eliminating or reducing moisture within a building structure by the steps of:
fastening a drainage/ventilation product including
a weather barrier membrane faces away from the building structure, the weather barrier is nonwoven and/or a perforated film, and the nonwoven is a spunbond nonwoven, meltblown nonwoven, and/or a combination of meltblown and spunbond nonwovens;
a drainage structure affixed to and co-extensive with the weather barrier membrane, the drainage structure is an entangled net with a channel configuration or a waffle configuration;
a moisture resistant layer affixed to and co-extensive with the drainage structure, the moisture resistant layer is a film or nonwoven;
an adhesive layer, the adhesive layer is a plurality of adhesive strips and/or scatter coated over and co-extensive with the moisture resistant layer, the adhesive is a pressure sensitive adhesive (PSA) based on acrylic and/or butyl polymers, the adhesive has a pull adhesion in a range of about 10-21 psi, the adhesive covers about 40-95% of a surface of the moisture resistant layer; and
a release layer releasably covers and is co-extensive with the adhesive layer, and
removing moisture within the building structure by moving air through the drainage structure of the moisture ventilation product.

12. The method of claim 11 wherein the building structure includes vents through which air moves through the drainage structure.

13. The method of claim 11 wherein the weather barrier membrane includes a flap.

14. The method of claim 11 wherein the release layer has a silicone surfaced adjacent the adhesive layer.

15. The method of claim 11 wherein the release layer is split layer.
